(19) United States
(12) Patent Application Publication
(10) Pub. No.: US 2013/0127128 A1
(43) Pub. Date: May 23, 2013

(54) Rolling Ball Bucket

(71) Applicant: Gregg Alan Meidl, Bartlesville, OK (US)

(72) Inventor: Gregg Alan Meidl, Bartlesville, OK (US)

(21) Appl. No.: 13/298,801

(22) Filed: Nov. 17, 2011

(51) Int. Cl. B62B 1/18; B62B 1/00; A45C 13/00

(52) U.S. Cl. 280/47.17; 224/576; 280/47.131

(57) ABSTRACT

A device for transporting equipment that includes a wheeled central container bucket with a removable lid, wherein said container bucket and the wheels are adapted to allow the container bucket to rotate backwards engaging the wheels with the ground. A retractable handle can be attached to the container bucket so that the retractable handle is extendable to twice the height of said container bucket to allow for stacking two buckets. The bucket can have an attached bat or stick holder that has an opening on a rear or side of the bucket (or anywhere else). A cushioned seat can be built into a top or bottom surface of the removable lid.

### BACKGROUND

1. Field of the Invention

The present invention relates generally to the field of ball buckets and more particularly to a wheeled container/bin designed to carry baseballs and other equipment to the field and to provide a convenient seat.

2. Description of the Prior Art

Sports teams and individuals bringing equipment to a playing field have the option of using wheeled carts, collapsible dollies, wagons or other tools of conveyance, some of which have an integrated seat. The prior art offers a container with a seat; a dolly with a seat; a conveying, wheeled apparatus with a seat; a dolly that conveys a bucket and has a seating platform; a seat that attaches to a baggage handcart; and a golf bag with a seat. It would be very advantageous to have a wheeled, portable container/bin with a retractable handle and a cushioned seat built into its removable lid, that is designed to carry baseballs and bats and other equipment to the playing field, and also to provide a convenient seat.

Remole in U.S. Pat. No. 7,040,635 teaches a Portable wheeled dolly for carrying receptacle of articles and collapsible chair. Weldon in U.S. Pat. No. 6,131,925 teaches a Beach Buddy. Chapman in U.S. Pat. No. 7,677,591 teaches a beach cart for recreation and sports. Maitland in U.S. Pat. No. 4,533,151 teaches a combination carrier, chair, and lounge/table. Dittmer in U.S. Pat. No. 5,669,659 teaches a combination chair and hand truck. Ohlsson in U.S. Pat. No. 6,196,560 teaches a combined trolley and seat. Archer in U.S. Pat. No. 7,364,172 teaches a device for transforming a stationary bucket into a rolling bucket, functioning as a lid, and also facilitating attachment of a substance removal device. Hillenbrand in U.S. Pat. No. 6,213,574 teaches a baseball dispenser. Fiedor in U.S. Pat. No. 5,971,333 teaches a movable self-supporting implement stand and convertible bucket external frame. Tsai in U.S. Pat. No. 5,695,246 teaches a seat device attached to baggage handcart. Gomez in U.S. Pat. No. 7,306,097 teaches a golf bag having integrated seating platform. Han in U.S. Pat. No. 6,443,405 teaches a golf bag with seating apparatus. Oku in United States published patent application 2009/0295108 teaches a mobile ball hopper and sport bag carrier. Craig in United States published patent application 2009/0230646 teaches a beach cart for recreation and sports.

None of the above-cited art teaches the advantageous combination of a wheeled, portable container/bin for transporting equipment, having a central container-bucket, a cushioned seat built into its removable lid, a retractable handle extending to the height of two container bins, a bat/stick holder; and an optional pocket.

### SUMMARY OF THE INVENTION

The present invention relates to a multi-use wheeled container/bin used for carrying sports equipment to a playing field. The Rolling Ball Bucket includes a wheeled container/bin with a retractable push-handle and a cushioned seat built into its removable lid. It is designed to carry baseballs and other equipment to the field and to provide a convenient seat. When it is parked, with the handle retracted and the lid in place, the present invention also serves also as a seat. The present invention can have at its center a large container/bin for sports equipment. The container/bin can include molded handle attachments; cut-outs for molded wheels; a molded baseball-bat or sports-stick holder; and one or more molded pockets. The bucket section can be engaged with a metal axle and plastic wheels. The container/bin can include a telescoping, retractable handle that can be pulled up to the height of two buckets, allowing support should an additional container be stacked atop the first. The invention can have a metal carrying handle, and its lid can include an integrated, cushioned seat. The device is designed for conveying sports or other equipment to a playing field, and for also providing a seat.

### DESCRIPTION OF THE FIGURES

Attention is now directed to several drawings that illustrate features of the present invention:

FIG. 1 a top-perspective view of the embodiment.

FIG. 2 is a front-perspective view of the embodiment in closed position.

FIG. 3 is a front-perspective view of the embodiment with lid off.

FIG. 4 is a rear-perspective view of the embodiment with retractable handle pulled up.

Several drawings and illustrations have been provided to aid in understanding the present invention. The scope of the present invention is not limited to what is shown in the figures.

### DESCRIPTION OF THE PREFERRED EMBODIMENT

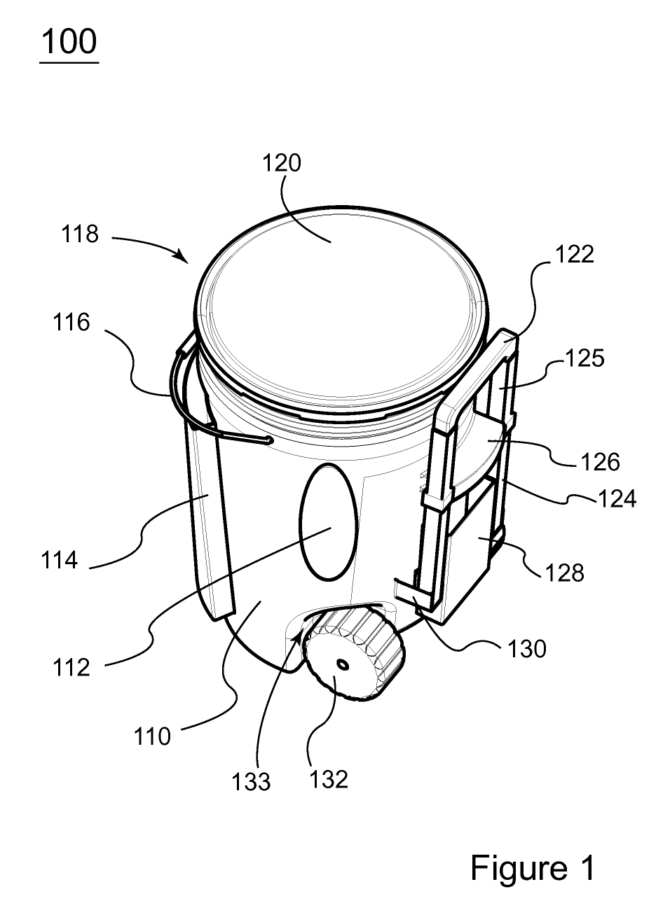

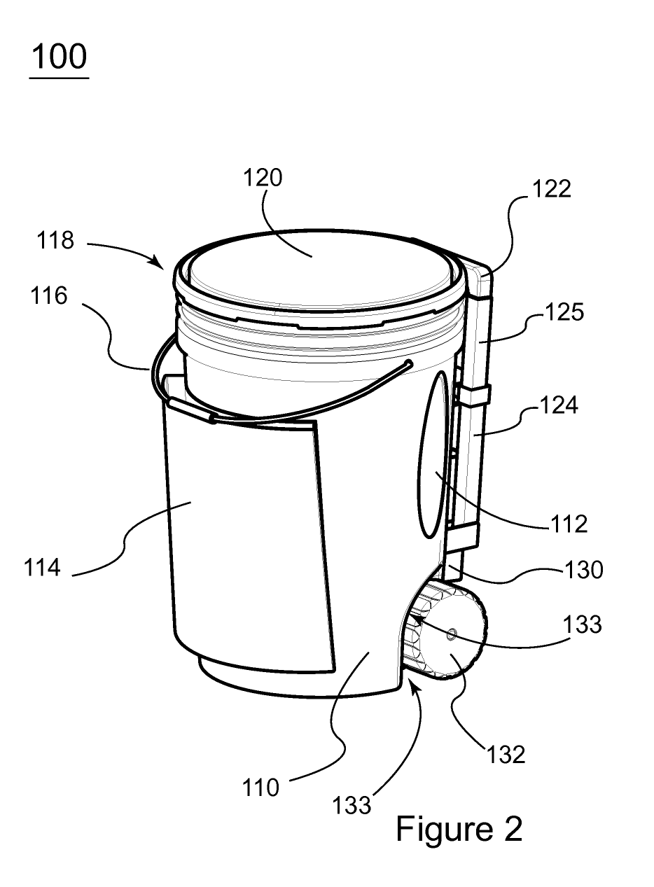

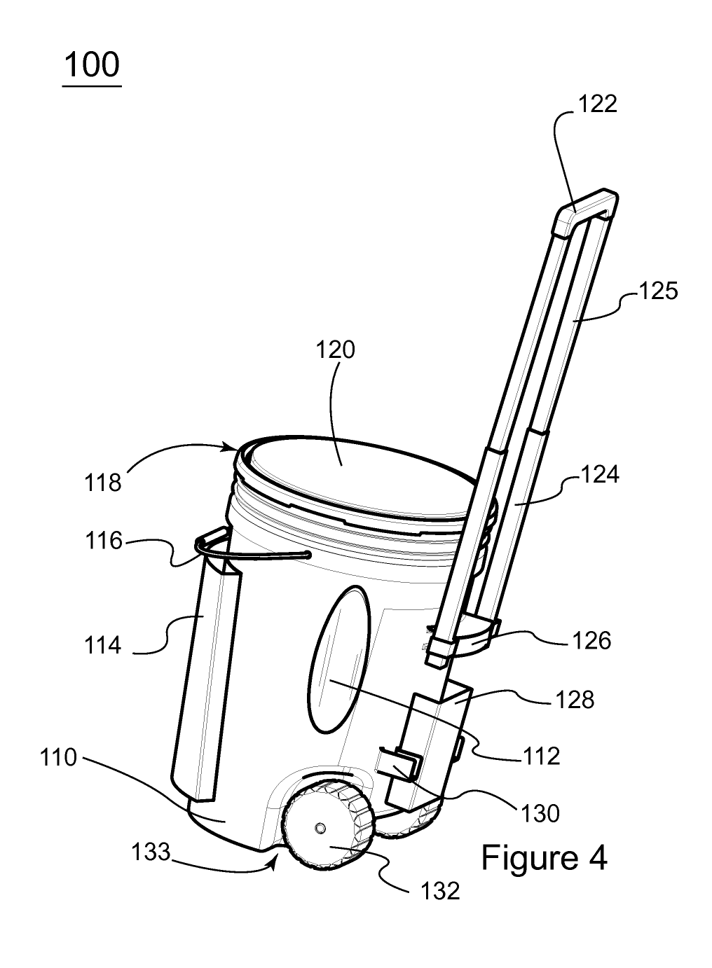

A preferred embodiment of the present invention is illustrated in FIGS. 1-4. FIGS. 1-2 show rolling container 100 including of a bucket 110 that has a cylindrical opening 112 for holding baseball bats or other handled equipment. FIGS. 1-2 also show a front pocket 114; a carrying handle 116 which is pivotally attached to the bucket, a removable lid 118 that is covered with a seating cushion 120 and fits atop the bucket and a retractable handle 122 is attached to the bucket body 110 via an attaching section 130. All of these parts can be molded from plastic or other semi-rigid material. In some embodiments, the carrying handle 116 can be pulled up and used to lock down the removable lid 118. In other embodiments, the removable lid 118 can lock onto the top of the container 100 using any type of latching or holding technique. The retractable handle 122 can be pulled from or retracted into a channel 124 which can be fixedly attached via attaching section 130 to the bucket 110. A protrusion 126 (shown in FIGS. 1 and 4) holds the channel for the retractable handle 122. A back pocket 128 is attached to the container body 110. Wheels 132 on an axle are attached to the container body. A recessed wheel-well 133 provides space around the wheels 132. In some embodiments, the wheels 132 can be equipped with a brake or wheel-locking mechanism (not shown).

FIG. 2 shows the embodiment of FIG. 1 in an upright position, the position for sitting upon. The retractable handle 122 is shown retracted, and the lid 118 with a cushioned seat 120 is in shown place. In the preferred embodiment of the invention, the cushioned seat 120 is located on the top of the removable lid 118; however, in other embodiments, it can be on the bottom of the lid or elsewhere. The cushion can be made from any soft or fluffy material. It can optionally have a water-resistant coating to keep it from absorbing moisture.

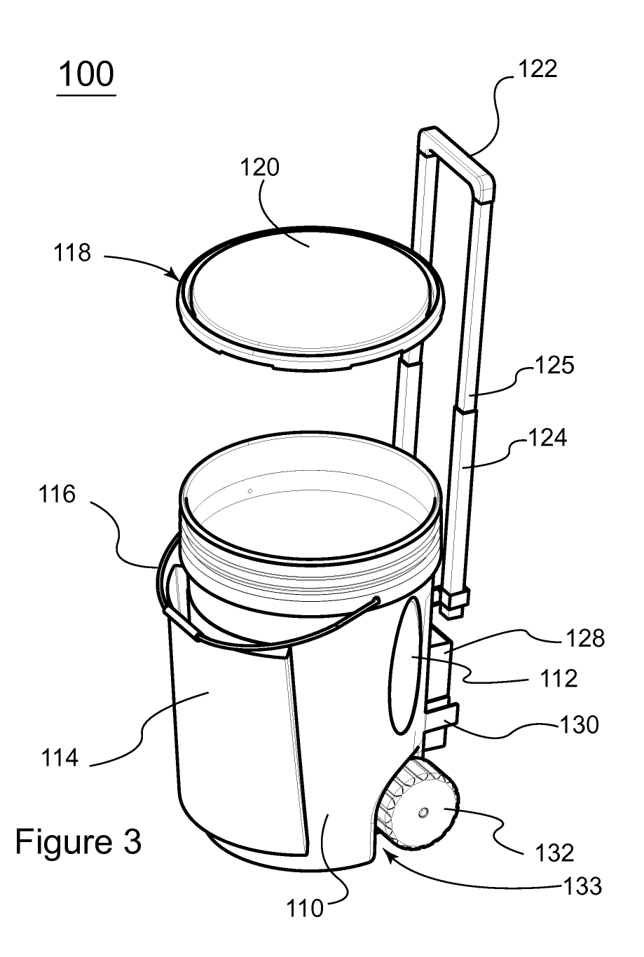

FIG. 3 shows the embodiment with lid/seat off, FIG. 4 is a rear perspective view of the embodiment showing the retractable handle extended. In some embodiments, the retractable handle 122 can generally click and latch at different heights; in other embodiments, the retractable handle 122 locks in a lower and an upper position. In still other embodiments, the retractable handle 122 slides smoothly and does not lock.

The front pocket 114, while preferably molded, can alternatively be cloth or any other material.

Although only a few example embodiments have been described in detail above, those skilled in the art will readily appreciate that many modifications are possible in the example embodiments without materially departing from this disclosure. Accordingly, all such modifications are intended to be included within the scope of the present invention.

I claim:

1. A device for transporting equipment comprising:
a central container bucket with a removable lid;
a retractable handle attached to said container bucket;
a bat or stick holder also attached to said container bucket;
a seat built into said removable lid.

2. The device of claim 1 wherein said retractable handle is extendable to twice the height of said container bucket.

3. The device of claim 1 wherein said seat is cushioned.

4. The device of claim 1 further comprising a front or side pocket attached to the container bucket.

5. The device of claim 1 further comprising a set of wheels at a lower end of said container bucket.

6. The device of claim 1 wherein said container bucket and said wheels are adapted to allow the container bucket to rotate backwards engaging said wheels with the ground.

7. The device of claim 4 wherein said pocket is attached to a front side of said container bucket.

8. The device of claim 1 wherein said stick or bat holder includes an elongated opening on a rear or side of said container bucket.

9. The device of claim 3 wherein the cushioned seat has a water-resistant coating.

10. A device for transporting equipment comprising:
a wheeled central container bucket with a removable lid, wherein said container bucket and said wheels are adapted to allow the container bucket to rotate backwards engaging said wheels with the ground;
a retractable handle attached to the container bucket, wherein said retractable handle is extendable to twice the height of said container bucket;
a bat or stick holder also attached to the container bucket, wherein said stick or bat holder includes an opening on a rear or side of said container bucket;
a cushioned seat built into a top or bottom surface of said removable lid.

11. The device of claim 10 wherein said cushioned seat has a water-resistant coating.

12. A method for transporting sports equipment to a sporting location comprising:
providing a wheeled central container bucket with a removable lid, wherein said container bucket and said wheels are adapted to allow the container bucket to rotate backwards engaging said wheels with the ground;
providing a retractable handle attached to said container bucket, wherein said retractable handle is extendable to twice the height of said container bucket;
attaching a bat or stick holder also attached to said container bucket, wherein said stick or bat holder includes an opening on a rear or side of said container bucket;
providing a cushioned seat built into a top or bottom surface of said removable lid.
